(19) United States
(12) Patent Application Publication
(10) Pub. No.: US 2026/0120156 A1
(43) Pub. Date: Apr. 30, 2026

(54) SYSTEMS AND METHODS FOR GENERATING CONTENT SUMMARIES WITH MINIMAL HALLUCINATIONS

(71) Applicant: Ford Global Technologies, LLC, Dearborn, MI (US)

(72) Inventors: Venkatarao Rebba, Dearborn, MI (US); Najibesadat Sadatijafarkalaei, McKinney, TX (US); Kai Wu, Pittsburgh, PA (US); Hyongju Park, Ann Arbor, MI (US)

(73) Assignee: Ford Global Technologies, LLC, Dearborn, MI (US)

(21) Appl. No.: 18/928,670

(22) Filed: Oct. 28, 2024

(51) Int. Cl. G06Q 30/0282; G06F 16/34; G06F 40/30

(52) U.S. Cl. CPC G06Q 30/0282; G06F 16/345; G06F 40/30

(57) ABSTRACT

Systems and methods for generating content summaries with minimal hallucinations are provided. Particularly, the systems and methods may be applicable to EV charging stations. One or more natural language processing models (NLP models), such as an aspect-based sentiment analysis model (ABSA) and a summarization model, may be used to generate summaries of information associated with the charging stations. A mechanism may also be used to ensure that the summaries that are generated are accurate and do not include hallucinations.

### FIELD

The present disclosure relates to systems and methods for generating content summaries with minimal hallucinations.

### BACKGROUND

As more drivers rely on electric vehicles (EVs) for their daily transportation needs, the necessity for reliable and user-friendly information about EV charging locations is becoming increasingly important. EV drivers rely heavily on customer reviews to choose suitable charging locations, but the sheer volume of reviews can make it challenging to quickly identify relevant insights. Currently, users must sift through numerous comments to find useful information about factors such as stations functionality, charging speed and overall experience. This process is time-consuming and inefficient, particularly when quick decisions are required.

The challenge is further complicated by the varied nature of customer feedback. Reviews often address different aspects, such as availability, reliability, and amenities, making it challenging for users to obtain a comprehensive understanding from a single review. Moreover, the presence of both positive and negative reviews can create confusion, as users need to weigh different opinions to form an overall judgment.

In addition, the public EV infrastructure in the USA encompasses a variety of charge point operators (CPO), each offering distinct mobile applications, features, and options. Due to the diversity in services, customers encounter unique issues at these charging stations that cause a poor charging experience. Fortunately, some previous users provide suggestions and solutions for these specific problems. Nevertheless, not all customers review these user comments, and for those who do, the process can be exceedingly time-consuming.

Another difficulty is the existence of multiple platforms for reviews. EV drivers often consult various data sources to gather comprehensive information. This fragmented information increases the complexity of making informed choices, as drivers spend additional time cross-referencing reviews, which detracts from the convenience that EV technology promises.

Finally, as the EV market continues to expand, the volume of reviews will increase, exacerbating these issues. The necessity for an efficient way to synthesize and present this information in a user-friendly manner is becoming more pressing. More importantly, this information can activate a digital service that assists EV drivers in identifying the optimal charging locations based on their personal preferences.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a flow diagram for generating content summaries with minimal hallucinations, in accordance with the present disclosure.

FIGS. 2A-2B depict a flow diagram for model training, in accordance with the present disclosure.

FIGS. 3A-3B depict a flow diagram of a feedback mechanism for model hallucination mitigation, in accordance with the present disclosure.

FIG. 4 depicts an exemplary summarization process, in accordance with the present disclosure.

FIG. 5 depicts an exemplary topic-level summarization, in accordance with the present disclosure.

FIG. 6 depicts an environment in which techniques and structures for providing the systems and methods disclosed herein may be implemented.

FIG. 7 depicts a flow diagram of a method for predictive vehicle navigation, in accordance with the present disclosure.

### DETAILED DESCRIPTION

### Overview

The present disclosure describes systems and methods for generating content summaries with minimal hallucinations (e.g., incorrect information included within the summaries). While the use case of generating summaries for EV charging stations is described herein, the approach may also be applicable to other use cases as well.

Users often desire to view concise summaries including key information for an area of interest to the user. However, such information is often not easily accessible in this concise format and requires the user to obtain pieces of information from various types of data sources. This results in a time-consuming and inefficient process, and, in some cases, the user may not be able to locate all the desired information. This typical process is especially detrimental in scenarios in which the user requires the information to make decisions in a short period of time (for example, if the user is driving and needs to identify an EV charging station to use, as is described in further detail below).

In the use case of EV charging stations, a user may desire to view concise information about key aspects of EV charging stations when the user is deciding which charging station to use to charge their vehicle (for example, if the user currently needs to charge their vehicle and is looking for a nearby charging station or if the user is planning a future trip and desires to pre-plan the route to include charging stations with attributes desired by the user). However, the typical source of this type of information includes user reviews posted on various types of online platforms, and it may be difficult for a user to navigate these data sources to efficiently find information about various charging stations.

The system described herein addresses these challenges by generating concise and useful summaries of information from the various data sources. Specifically, the system includes multiple natural language processing (NLP) Models. In some embodiments, the models may include an aspect-based sentiment analysis model (ABSA) and a summarization model, however, any other number of models (and combinations of different types of models) may also be used. In some instances, a single model may be used to perform all tasks described herein as well. These models may be developed using large language models (LLMs) by employing both prompt engineering and fine-tuning techniques.

Returning to the use case of EV charging stations, the system leverages the NLP models to summarize customer reviews for EV charging locations (and/or any other relevant information).

By employing aspect-based sentiment analysis (ABSA), the system may generate detailed summaries across various topics, such as functionality, charging speed, customer service, and amenities, as non-limiting examples. This approach not only condenses information from various data sources into an easily digestible format but also ensures that users receive nuanced insights into specific aspects of their charging experience. Moreover, the system may receive periodic (e.g., daily or any other period of time) snapshots from each data provider. Accordingly, the summaries produced by the system are based on the most recent data from the various data sources.

With respect to this use case, the system addresses the core challenges of information overload and fragmented feedback, enabling EV drivers to make informed decisions quickly and efficiently. The system enhances the user experience by providing clear, concise, and relevant information, thereby improving the overall satisfaction of EV drivers with the charging infrastructure. Additionally, the system uses the NLP models to analyze community reviews and identify common problems and their solutions. These insights are particularly valuable for new EV drivers using specific charging stations, enhancing their overall experience and ensuring a seamless charging process.

In some embodiments, the system may also be integrated into a consumer-facing application, providing users with enhanced decision-making capabilities when selecting a charging station and determining the best charging solutions for their vehicles. For example, the user may leverage the application to not only search for available charging stations but also to view the summaries of the charging stations produced by the system, thereby allowing the user to make a more informed decision.

To ensure the relevancy of the summaries, the system may also incorporate various triggers for updates. For example, when a user uses the application to select and utilize a charging location, the application may prompt the user to provide feedback about the accuracy and helpfulness of the summarization provided by the application. If the feedback confirms that the current summary is satisfactory, the summary is retained. However, if the feedback is unsatisfactory, the models (e.g., ABSA and/or summarization) may be refined to enhance the summary. As another example, the system may regularly update the summaries after a certain threshold number of new comments are received. The summarization job is scheduled to run periodically (e.g., daily, weekly, etc.) and based on the number of new comments from the past summary, the new summarization may be inferred. To ensure the time relevancy of comments a threshold may be established and only information within the threshold may be considered (e.g., information that is less than three months old or any other timeframe). This continuous feedback loop ensures that the summaries evolve with user experiences and maintain their relevance and accuracy.

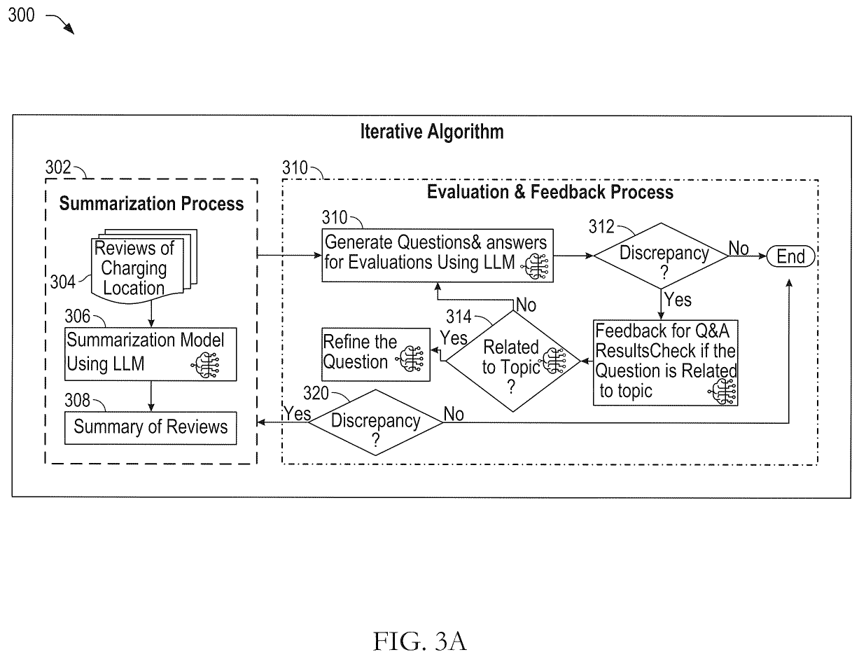

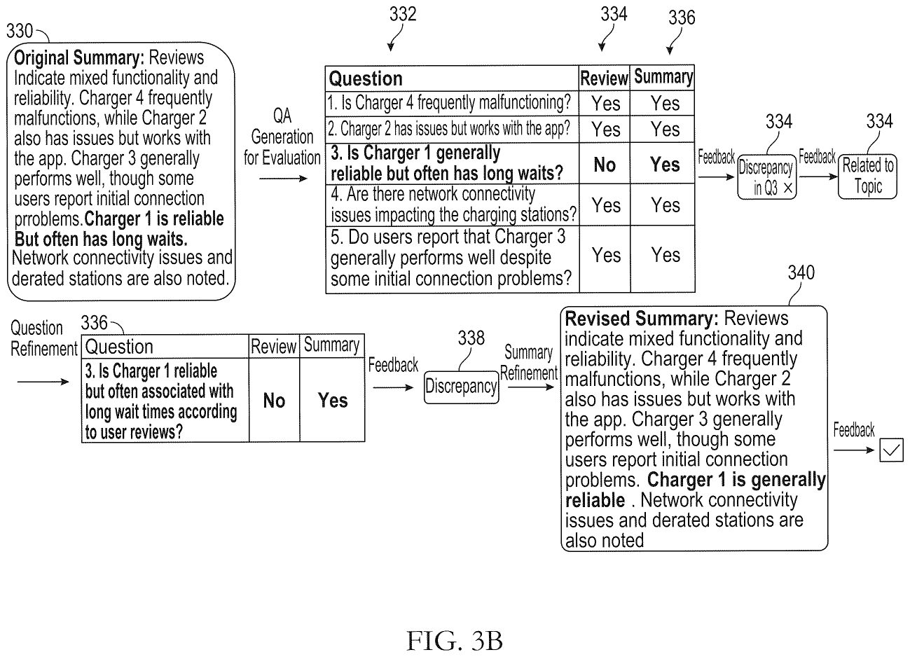

One challenge associated with producing summaries using these types of models is that the models often produce hallucinated information, meaning that the models produce information that is not accurate or is otherwise not based on factual information. Accordingly, the system described herein not only provides an approach for generating summaries of information in different formats and from different data sources into one concise and easily accessible format that may be viewed via a user interface of an application, but also addresses technical challenges associated with using models for such summarization tasks. That is, the system reduces or eliminates the hallucinations produced by such models to ensure that the summarized information is not only convenient but is also accurate. The specific enhancements to the models used to mitigate or eliminate hallucinated information are described with respect to at least FIGS. 3A-3B.

Again, turning to the example of EV charging stations, the system offers several advantages over existing methods, significantly enhancing the EV charging experience through summarization of user reviews and other types of relevant information. Current approaches require manual review of siloed and segmented raw data in the form of user reviews provided across multiple platforms. These reviews are often difficult to digest due to their fragmented nature and varying formats. The system described herein, in contrast, provides users with quick and easy access to summarized reviews, highlighting the most relevant and critical information about charging stations. This reduces the time and effort required to sift through information, allowing users to make informed decisions rapidly. By generating both overall and detailed summaries based on specific topics through ABSA, such as functionality, charging speed, and customer service, users receive nuanced insights into various aspects of their charging experience. This detailed information helps users understand the strengths and weaknesses of each charging location comprehensively. The use of ABSA to identify sentences related to each topic, combined with the summarization model, highlight potential issues and previous customer suggestions. This approach helps users understand what to expect and make more informed decisions, ensuring a more reliable and seamless charging experience. Additionally, the implementation of large language models (LLMs), along with fine-tuning techniques for ABSA and summarization, ensures that the solution can efficiently handle a growing volume of reviews. This capability allows the system to scale with the increasing number of users and charging stations, continuously improving as more data becomes available. Further, the adaptability of these models ensures they remain effective as new patterns and topics emerge in customer feedback, making the solution robust and sustainable.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

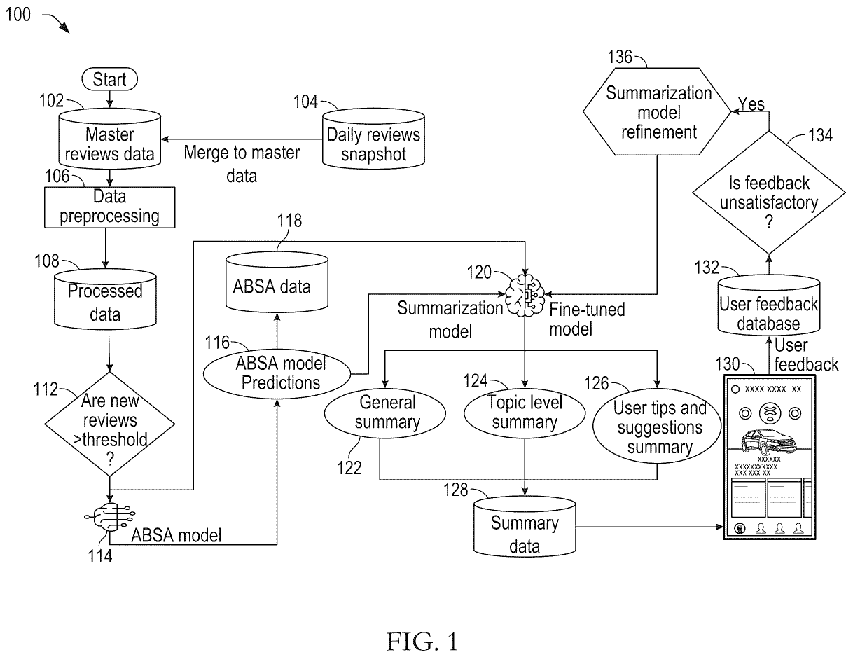

FIG. 1 depicts a flow diagram 100 for generating content summaries with minimal hallucinations. The flow diagram 100 depicts some of the exemplary operations that may be performed by the system as described herein. However, the flow diagram 100 is not intended to be limiting in any way and the system may also perform more or less operations than those shown in FIG. 1.

The flow diagram 100 shows a master database 102 that may include any of the data obtained from various data sources 104 that is used to generate the summaries as described herein. The flow diagram 100 also shows that data may be obtained from the various data sources 104 periodically to update the data stored in the master database 102. The master database 102 may also be updated with data from the data sources 104 in real-time as well.

Initially, the summarization process may optionally involve, at operation 106, performing pre-processing on any of the data that is stored in the master database 102. For example, for the use case of EV charging stations, the data stored in the master database 102 may include user reviews obtained from the various data sources 104. However, some of the user reviews may be provided in a format that is difficult for the models (for example, the ABSA model 114 and/or the summarization model 120) to process. In some instances, the models may be able to process all of the data, however, some of the data may not include useful information (or may include incorrect information) and it may be undesirable for that data to be used by the models. For example, an erroneous user review may not include any information, or a user review may include certain non-alphanumeric characters or other types of symbols. In these examples, the pre-processing may involve removing the erroneous user reviews from the master database 102 and/or removing the certain non-alphanumeric characters or other types of symbols. However, any other types of changes to the data (including removing data) may be made as a part of the pre-processing.

Once the data is pre-processed (if pre-processing is performed), the processed data 108 may then be used to generate summaries for all locations. The summarization process may be performed as follows. The ABSA model 114 may receive the processed data (continuing the exemplary use case, the ABSA model 114 may receive the user reviews and/or any other data relevant to the charging stations). At operation 116 the ABSA model may use the data to perform predictions. Specifically, the ABSA model 114 may process the data to identify portions of the data that are useful for summary generation. The ABSA model 114 may also categorize the data. For example, as described elsewhere herein, pre-determined categories of information that may be relevant to a user may be established and the ABSA model 114 may determine if the data is associated with any of the pre-determined categories (examples of these categories are shown in Table 1, which is provided below, however, these examples are not intended to be limiting in any way).

TABLE 1

| Topic | Definition | Examples |
|---|---|---|
| Functionality | Functionality may refer to | “Charging stops intermittently on |
| and | comments describing whether | the right dock.” |
| Reliability | particular features or services | “I have noticed that at around |
| | are working properly. | 2 hrs the charge rate slows down, to |
| | | return it to normal I have found |
| | | stopping the charge with the app and |
| | | then immediately re-starting works |
| | | great!” |
| Accessibility | Availability may refer to | “2 out of the 4 chargers were |
| and | comments concerning whether | down” |
| Availability | chargers are available at a | “There is long line for the |
| | given station. | charger” |
| | The user access category may | “Security said is for employees |
| | refer to the comments where | only” |
| | the general public is not | |
| | allowed to charge at the | |
| | location. | |
| Location | The location category may | “Spot on the 2nd floor of the |
| | refer to comments about | parking deck” |
| | various features or aspects | “Located very close the store, on |
| | specific to a particular | the north end of the parking area.” |
| | charging station location. | “The GPS took me to a wrong |
| | | place” |
| Cost | The cost category may refer to | “Charged for free” |
| | reviews that discuss parking, | “Valet park for parking charge” |
| | charging fees, and payment. | |
| Amenities | The amenities category may | “Great place to charge, lovely |
| and Facilities | refer to comments mentioning | downtown shopping and restaurants” |
| | the pleasantness | “Next to Holiday Inn Empress, |
| | or attractiveness of the | Lucille's restaurant” |
| | charging location. | |
| User Tips | User tips may refer to | “Free. Wants either a chargepoint |
| and | comments in which users are | RFID card, or Chargepoint app, or |
| Suggestions | directly interacting with other | other RFID credit card to start |
| | vehicle owners in the | session, but costs $0.” |
| | community. | “Charged my zero. You have to |
| | | download the app, which is |
| | | annoying, but it works.” |
| | | “Couldn't charge. Called the |
| | | company and they are aware but |
| | | aren't fixing it. Don't rely on this |
| | | place” |
| Charging | The charging speed category | “slow charge”/”charged very |
| Speed and | may refer to comments | fast” |
| Efficiency | reporting charging rates | “3A isn't very fast. Moved to 4A |
| | experienced in a session. | and it was better” (adjectives |
| | | describing speed of charging such as |
| | | fast, slow is also considered for |
| | | service time) |
| Customer | The customer service category | “Few probs connection but tech |
| Service | may refer to comments | support got me up and charging.” |
| | concerning hospitality | “Talk to the front desk to use the |
| | provided at the charging | charger so you don't get towed if |
| | station | you're not a guess. Had to use the |
| | | charger with my own adapter.” |
| Safety | The safety category may refer | “Charging fault on both plugs. |
| | to the comments relating to | No sign of life (no lights etc.).” |
| | user perspectives about the | |
| | safety of a charging station. | |

The ABSA model 114 may also determine a “sentiment” of the data or portions of the data. For example, the ABSA model 114 may determine whether each sentence within a given user review is “positive,” “negative,” or “neutral” (however, other sentiment categorizations may also be used). An overall sentiment for the user review may also be determined based on the sentiments assigned to each of the sentences that form the entirety of the user review. The ABSA model 114 may output the results of these predictions (and/or any other relevant information) as first output data 118.

Once the first output data 118 is generated by the ABSA model 114, the first output data 118 and the input data may be provided to the summarization model 120. The summarization model 120 may then use this information to generate one or more summaries that may be presented to a user (for example, via a user interface of an application). In some embodiments, the one or more summaries may include a general summary 122, a topic level summary 124, and a user tips and suggestions summary 126. These types of summaries are merely exemplary and other types of summaries may also be provided by the summarization model 120 as well.

The general summary 122, for example, may provide an overarching view of all user feedback related to a particular EV charging location. The general summary 122 consolidates the major points of interest and concern from all reviews, giving users a quick snapshot of the station's overall performance and user satisfaction. This general summary 122 helps users get an immediate sense of what to expect without delving into specifics. As an example of a general summary 122, most reviews highlight mixed experiences with functionality and reliability. Some users experienced issues with payment methods, connection errors, and charging interruptions. Others reported seamless and reliable charging sessions. Most reviews indicate that the availability and accessibility of EV charging stations are generally positive. Most users found all stations online and available, though some experienced initial connection issues. Mixed feedback with charging speed and efficiency; Some users reported fast charging speeds, while others noted slower rates and discrepancies in billed versus received kWh. Most users found the locations of the charging stations to be convenient. Users appreciated the clean, well-lit stations with nearby amenities like convenience stores. Mixed experiences with customer service. Some users had difficulty reaching customer service or resolving issues, while others found the staff friendly and helpful.

The topic level summary 124, for example, may focus more on specific areas of interest, the topic level summary breaks down the general feedback into categorized themes such as functionality and reliability, charging speed and efficiency, and customer service. Each summary may capture the essence of user sentiments within that theme, allowing users to understand detailed aspects of the charging experience which are most relevant to their needs.

The user tips and suggestions summary 126, for example, may compile practical tips and suggestions provided by users, such as particular issues to be aware of at certain stations. The user tips and suggestions summary 126 may provide actionable advice from the community of users, enhancing the utility of the summarization by incorporating peer-to-peer wisdom and recommendations.

These are merely exemplary types of summaries that may be generated, and any other types of summaries may also be generated.

Furthermore, the system may receive feedback on the summarization feature displayed via the client-facing application 130. If the feedback is deemed unsatisfactory and the user indicates that enhancements are necessary, the system may trigger a process to refine the model and re-compute the summary.

Even after the initial summaries are generated by the summarization model 120, the system may generate updated summaries based on new information that is received. In some instances, the system may automatically process any new information that is received such that the summaries are updated in real-time. However, in other instances (as shown in the flow diagram 100), the system may only periodically update the summaries depending on the amount of new information that has been received. For example, flow diagram 100 shows condition 112, which involves determining whether the amount of new information is greater than a defined threshold. In this exemplary implementation, if the number of new comments for a location since the last summary exceeds the threshold, then any summaries may be updated by the ABSA model 114 and the summarization model 120. This ensures that the summaries are not static but are continuously enhanced and updated. In the use case of EV charging stations, this dynamic approach allows EV drivers to always access the most relevant and up-to-date information, enhancing their decision-making process and overall satisfaction with the charging infrastructure.

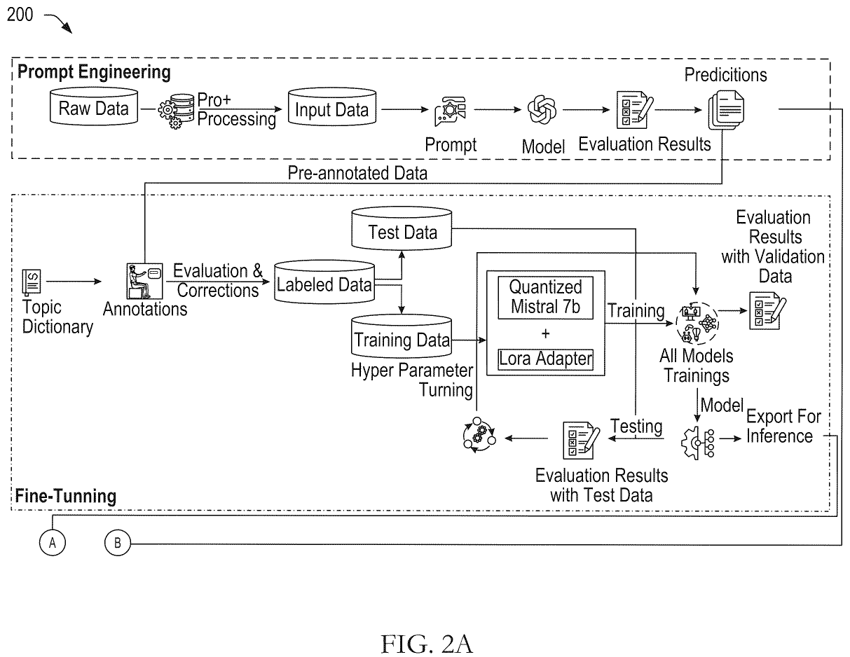

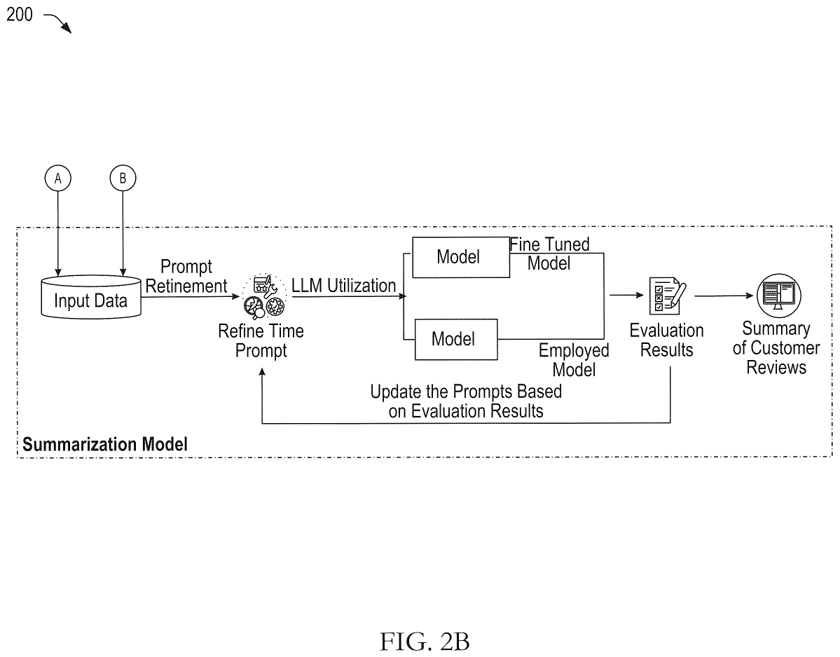

FIGS. 2A-2B depict a flow diagram 200 for model training. Initially, prompt engineering techniques are employed to predict the ground truth for training samples which saves a lot of time from labeling data from scratch. Thereafter, the system evaluates and corrects the ground truth data (or this process may be performed manually by a user). The labeled data is used to fine-tune a large language model to achieve great performance in EV domain space (or other applicable domain space).

FIG. 3A depicts a flow diagram 300 of a feedback mechanism for model hallucination mitigation. Evaluating summarization using large language models (LLMs) is challenging due to difficulties in providing ground truth, which makes it hard to consistently measure the quality of summaries. To address these issues, an iterative self-refinement algorithm with a feedback loop is implemented. In some embodiments, the flow diagram 300 may include a summarization process 302 and an evaluation and feedback process 310.

Beginning with the summarization process 302, input data 304 may be received. For example, in the use case of EV charging stations, the input data 304 may include user reviews of the charging stations (and/or any other relevant information). Operation 306 involves generating the summaries 308 of the charging stations using the input data 304. For example, the summaries 308 may be generated by the summarization model as described herein.

Turning to the evaluation and feedback process 310, the summaries 308 and the input information 304 may be provided to a “question-answering generation model” (which may be, for example, a large language model or any other type of suitable model) to generate one or more questions that relate to the information included in the input data 304 and the summaries 308 (in operation 310). The question-answering generation model may also generate a first set of answers based on the content of the input data 304 and a second set of answers based on the summaries 308. An example of questions and answers generated for a summary is shown in FIG. 3B.

Once the questions and sets of answers are generated by the questions and answers model, condition 312 involves determining if there is a discrepancy between the information included the first set of answers and the second set of answers. In some instances, the answers included in each of the two sets of answers may be “yes” or “no” answers and the discrepancy determination may involve determining if an answer to one question for one of the sets of answers is a “yes” and an answer to the question for the other set of answers is a “no”.

Although the example in FIG. 3B shows “yes” and “no” answers, this is merely exemplary, and the answers are not necessarily limited to just “yes” and “no” answers. If the question types are extended to include more descriptive responses, a semantic similarity measure, such as BERTScore (or any other suitable technique), may be implemented to compare the answers. This would allow the system to assess whether two answers are substantively similar, even if they differ in wording. Using BERTScore or similar methods would enable the model to focus on the semantic content of the responses and ensure that the generated answers align meaningfully, rather than relying solely on exact phrasing.

Then condition 314 involves determining if the questions generated by the questions and answers model are related to the topic. In some embodiments, the determination of whether the questions are related to the topic may be made using a large language model, in a self-feedback loop. The model may be prompted to assess whether the generated question is relevant to the specific topic. This may be achieved through a carefully refined prompt that asks the model if the questions align with the given topic.

If a discrepancy is detected, the questions are refined at operation 318, and their relevance to the topic is again checked. If the question is not related to the topic, feedback is provided to ensure proper alignment. This iterative approach allows for continuous refinement and enhancements of the summarization and evaluation process, reducing hallucinations and contradictory information in the summary results, thereby enhancing both accuracy and consistency.

FIG. 3B shows an example of this hallucination mitigation process described with respect to FIG. 3A. The example shows an initial summary 330 that was generated by a summarization model for an EV charging station. Using the initial summary 330, the question and answers model generates one or more questions 332 and a first set of answers 334 and a second set of answers 336 to the questions. For example, FIG. 3B shows five different questions that were generated by the questions and answers model based on the initial summary 330 and the input data that was used to generate the initial summary 330. FIG. 3B also shows two sets of five different answers for each of the five questions, with a first set of answers 334 being based on the input information and the second set of answers 336 being based on the information included in the initial summary 330. At operation 334, the system determines that there is a discrepancy between the answer to the third question included in the first set of answers 334 and the answer included in the second set of answers 336.

At operation 334, the system determines that the third question is related to the topic. Accordingly, operation 336 involves refining the third question. For example, FIG. 3B shows that the third question is refined from “is Charger 1 generally reliably but often has long waits” to “is Charger 1 reliable but often associated with long wait times according to user reviews”. The questions and answers model is then used to generate updated answers based on the refined question. At operation 338, it is still determined that there is a discrepancy between the answer to the third question included in the first set of answers 334 and the answer included in the second set of answers 336. An indication of this continued discrepancy is provided to the summarization model and the initial summary 330 is revised by the summarization model to the revised summary 340. The revised summary adjusts the highlighted sentence shown in the initial summary 330 to “Charger 1 is generally reliable” in the revised summary 340 to provide more accurate information.

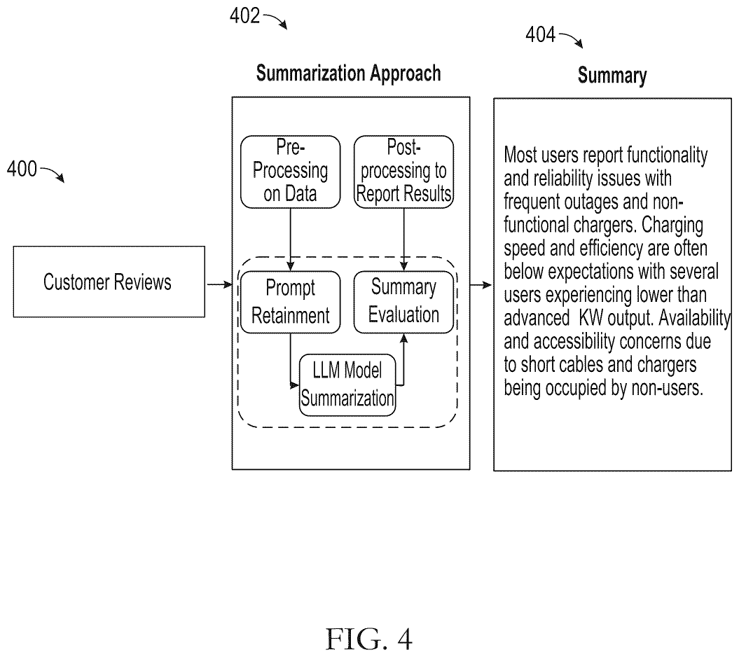

FIG. 4 depicts an exemplary summarization process 400. Using NLP models, two types of summaries may be produced: (1) an overall summary and (2) a detailed summary by topic. The overall summary provides a high-level view of the user feedback, capturing the general sentiment and key points from the collected reviews. For instance, an overall summary might highlight common issues like frequent outages, non-functional chargers, and customer service problems, as well as positive aspects such as charging speed and station amenities. The detailed summary by topic delves deeper into specific aspects identified by ABSA, such as functionality, reliability, charging speed, customer service and amenities. By summarizing comments related to each topic separately, the system ensures that users get a comprehensive understanding of the previous charging experiences of each critical aspect.

The ABSA may identify the overall sentiment of each topic for each location. For example, there may be a collection of pre-defined sentiment categories (e.g., positive, negative, or neutral), and the ABSA may categorize portions of all of a user review as one of the pre-defined sentiments. In some instances, however, the ABSA may not need to rely on pre-defined categories and may instead generate a sentiment categorization that is not pre-defined. In one exemplary implementation, the ABSA may categorize each sentence of a user review (or portions of a sentence). In this implementation, the overall sentiment for the user review may be determined by comparing each of the sentiment categories to a threshold percentage. For example, if more than a 70% of sentences for a particular topic are categorized as “positive,” then the system may consider the topic as having overall positive feedback (similar logic may apply for negative and neutral sentiments). Alternatively, the system may determine which of the categories of sentiments is more prevalent. For example, if the ABSA determines that three sentences are “positive” and one is “neutral”, then the system may determine that the user review is overall positive.

Additionally, the system may apply extra weight to feedback provided by user after reviewing the summary generated by the system. This weighted sentiment is then updated as new comments are added, ensuring the sentiment reflects the most current user experiences.

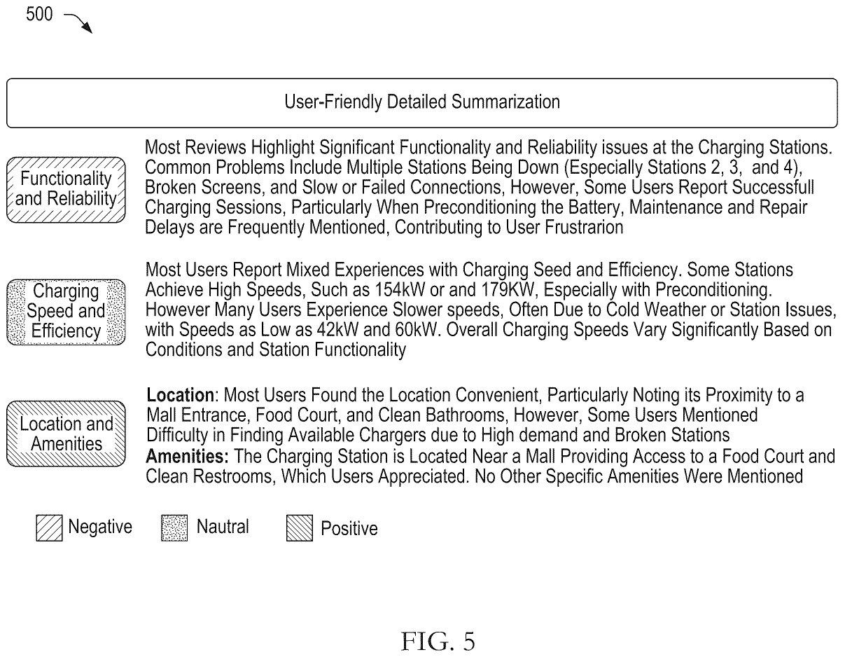

FIG. 5 shows an exemplary summary 500 generated by the system as described herein. FIG. 5 shows that summaries may be generated for different types of attributes that are relevant to the use case. In the example of an EV charging station, some examples of such attributes may be functionality and reliability, charging speed and efficiency, and location and amenities. Other attributes may also be summarized as well. The attributes that are summarized for a given use case may, in some cases, be pre-defined and the same types of attributes may be summarized for all users. However, a user may have the capability to manually indicate which of the attributes are most desirable to them and the summaries that are presented to them via the user interface may only include those indicated attributes. The system may also automatically determine which of the attributes are most relevant to the user without receiving a manual indication in some instances as well.

The system may also leverage user feedback to enhance the accuracy of the outputs produced by the model(s). EV drivers often encounter unique challenges at charging stations, which can exacerbate their range anxiety and hinder their ability to charge their vehicles effectively. In such situations, drivers typically seek assistance from customer support. However, if customer support is unresponsive, drivers may face difficulties in completing the charging process.

As a first example, a user faces issues in activating the charger due to the absence of a physical FLO card or problems with the mobile application associated with the charging station. This issue may be resolved if one of the previous users who experienced a similar challenge provided a review detailing how to activate the charger using the mobile application by adding the physical card.

As a second example, one of the charging stations may be experiencing issues and is not accepting card payments and is only accepting payments via a mobile application. This issue may be resolved if a previous user suggested tapping the card on the payment device for 5-10 seconds.

To address these common challenges faced by users, the system focuses on extracting key user suggestions using a combination of ABSA and a summarization model tailored for user tips and suggestions. That is, the ABSA model may be to identify and filter out all reviews categorized under user tips and suggestions. This step aims to isolate user-generated content that offers valuable insights and solutions. Subsequently, the summarization model may compile and summarize the extracted reviews. This model plays an important role in synthesizing user suggestions into actionable recommendations for users. By leveraging these models, the solution aims to empower users by providing them with practical solutions to common problems encountered at charging stations. This approach enhances the user experience and assists users in overcoming challenges, ultimately contributing to a more seamless and efficient charging process.

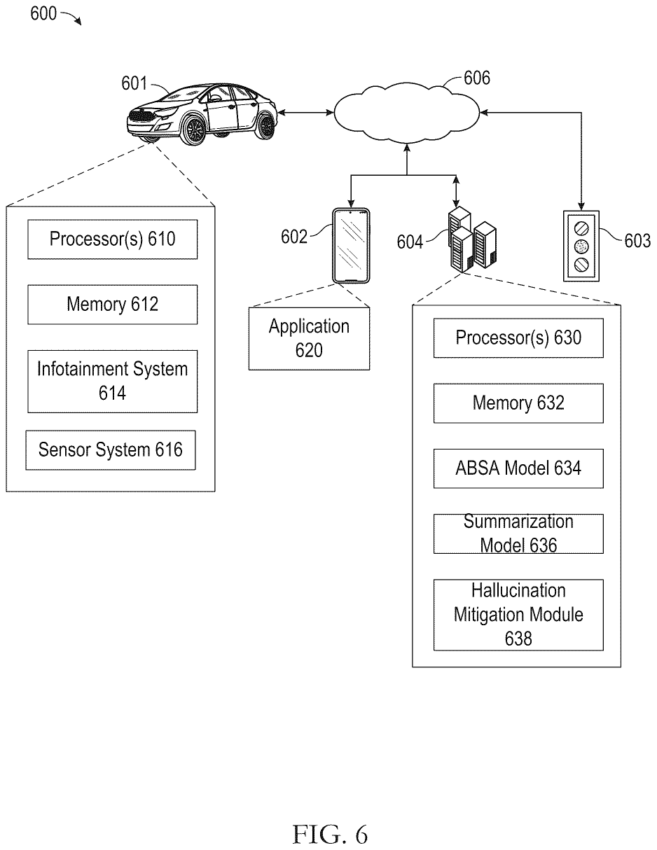

FIG. 6 depicts a block diagram of a system 600 for predictive vehicle navigation in accordance with the present disclosure. The system 600 may include the one or more vehicles 601, one or more user devices 602, infrastructure 603, and one or more servers 604 (or server 604) communicatively coupled with each other via one or more networks 606 (or a network 606). The system 600 is not necessarily intended to be comprehensive but merely illustrates exemplary components that may be included in the exemplary system 600. Any reference to a single element (e.g., a “server 604,” etc.) may similarly refer to any other number of such elements. Similarly, reference to multiple of such elements may also refer to a single element as well.

The vehicle 601 and/or the driver implement and/or perform operations, as described here in the present disclosure, in accordance with the owner manual and safety guidelines. In addition, any action taken by the driver based on the notifications/alerts provided by the vehicle 102 should comply with all the rules specific to the location and operation of the vehicle 601 (e.g., Federal, state, country, city, etc.). The notifications/alerts, as provided by the vehicle 601, should be treated as suggestions and only followed according to any rules specific to the location and operation of the vehicle 601.

The user device 602 may be associated with a user and may be, for example, a mobile phone, a laptop, a computer, a tablet, a wearable device, or any other similar device with communication capabilities. The user device 602 may include an application 620 that presents a user interface to the user. The application 620 may present the summaries generated by the summarization model 636 as described herein. Additionally, in the use case of EV charging stations, the application 620 (or another application not shown in the figure) may be used by the same or other users to submit user reviews about a particular charging station. These user reviews may then serve as input data that is processed by the server 604 to generate the summaries.

The server 604 may be configured to receive data from the one or more vehicles 601, user device 602, infrastructure 603, and/or any other devices that are configured to capture data about a location. The server 604 may also be configured to process any of the data as described herein. For example, the server 604 may host any of the models that are used for summary generation, hallucination mitigation, and any other related tasks as described herein. As aforementioned, some or all of the processing may also be performed by the one or more vehicles 601, the user device 602, etc. Thus, the one or more machine learning models may also (or alternatively) be hosted on the one or more vehicles 601, the user device 602, etc. Accordingly, the server 604 may include the ABSA model 634, summarization model 636, and a hallucination mitigation module 638, which may leverage the questions and answers model as previously described.

The network 606 illustrates an example communication infrastructure in which the connected devices discussed in various embodiments of this disclosure may communicate. The network 606 may be and/or include the Internet, a private network, public network or other configuration that operates using any one or more known communication protocols such as transmission control protocol/Internet protocol (TCP/IP), Bluetooth®, BLE, Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

Any of the elements of the system 600 may also form a mesh network. This may be beneficial in scenarios in which a particular device is not connected to a wide-area network and is not able to transmit data over large distances (for example, from a vehicle to server 604). In such scenarios, the device that is unable to perform long-range communications may still be able to perform short-range communications with other proximate devices. For example, traffic infrastructure may capture an image of a location but may be unable to transmit the data to server 604. Instead, the traffic infrastructure may transmit the image to a vehicle in the vicinity and the vehicle may then transmit the data to server 604. Such data transmissions may also be performed between any other types of devices.

In some aspects, the user device 602 may be configured to connect with the automotive computer 608 and/or the system 612 via the network 606, which may communicate via one or more wireless connection(s), and/or may connect with the one or more vehicles 601 directly by using near field communication (NFC) protocols, Bluetooth® protocols, Wi-Fi, Ultra-Wideband (UWB), and other possible data connection and sharing techniques.

Any the components of the system 600 may also include one or more processor(s) (for example, processor(s) 610, 630, etc.) may be disposed in communication with one or more memory devices disposed in communication with the respective computing systems (for example, memory 612, memory 632, etc.). The processor(s) may utilize the memory to store programs in code and/or to store data for performing aspects in accordance with the disclosure. The memory may be a non-transitory computer-readable storage medium or memory storing an interface management program code. The memory may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). Although only the vehicle 601 and the server 604 as shown as having processors and memory, this is merely for illustrative purposes and any of the other components of the system (such as the user device 602 and the infrastructure 603) may also include processors and memory.

In some aspects, the vehicle 601 may also include an infotainment system 614 (or a vehicle Human-Machine Interface (HMI)). The infotainment system 614 may include a touchscreen interface portion and may include voice recognition features, biometric identification capabilities that may identify users based on facial recognition, voice recognition, fingerprint identification, or other biological identification means. In other aspects, the infotainment system 614 may be further configured to receive user instructions via the touchscreen interface portion and/or output or display notifications, navigation maps, etc. on the touchscreen interface portion. Similar to the application 620 of the user device 602, the infotainment system 614 may present the generated summaries to the user. That is, the user may view the summaries via the user device 602 and/or the vehicle 601. The information may also be presented to the user in other ways as well. The vehicle 601 may also include a sensor system 616 that may include any number of different types of sensors.

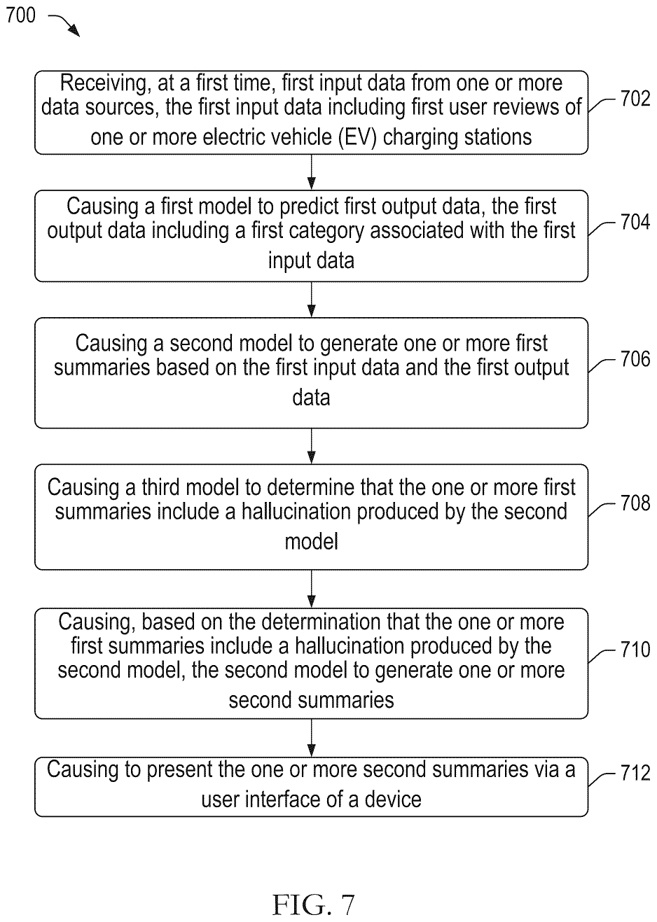

FIG. 7 shows an exemplary method 700. The method 700 starts at step 702. At step 702, the method 700 may include receiving, at a first time, first input data from one or more data sources, the first input data including first user reviews of one or more electric vehicle (EV) charging stations. At step 704, the method 700 may include causing a first model to predict first output data, the first output data including a first category associated with the first input data. At step 706, the method 700 may include causing a second model to generate one or more first summaries based on the first input data and the first output data. At step 708, the method 700 may include causing a third model to determine that the one or more first summaries include a hallucination produced by the second model. At step 710, the method 700 may include causing, based on the determination that the one or more first summaries include a hallucination produced by the second model, the second model to generate one or more second summaries. At step 712, the method 710 may include causing to present the one or more second summaries via a user interface of a device.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A system comprising:
memory that stores computer-executable instructions; and
one or more processors configured to access the memory and execute the computer-executable instructions to:
receive, at a first time, first input data from one or more data sources, the first input data including first user reviews of one or more electric vehicle (EV) charging stations;
cause a first model to predict first output data, the first output data including a first category associated with the first input data;
cause a second model to generate one or more first summaries based on the first input data and the first output data;
cause a third model to determine that the one or more first summaries include a hallucination produced by the second model by:
causing the third model to generate one or more first questions using the first input data and the one or more first summaries;
causing the third model to generate one or more first answers to the one or more first questions based on the first input data and one or more second answers to the one or more first questions based on the one or more first summaries; and
determining a difference between the one or more first answers and the one or more second answers;
cause, based on the determination that the one or more first summaries include a hallucination produced by the second model, the second model to generate one or more second summaries; and
cause to present the one or more second summaries via a user interface of a device.

2. The system of claim 1, wherein the first model is an aspect based sentiment analysis (ABSA) model and the second model is a summarization model.

3. The system of claim 1, wherein:
the first user reviews include one or more problems associated with the one or more EV charging stations and one or more solutions to the one or more problems; and
the one or more first summaries include the one or more problems and the one or more solutions.

4. The system of claim 1, wherein determining that the one or more first summaries include a hallucination further comprises:
cause the third model to refine the one or more first questions to produce one or more second questions;
cause the third model to generate one or more third answers to the one or more second questions based on the first input data and one or more second answers to the one or more second questions based on the one or more first summaries; and
determine a second difference between the one or more first answers and the one or more second answers, wherein causing the second model to generate the one or more second summaries is based on the second difference.

5. The system of claim 1, wherein the one or more processors are further configured to execute the computer-executable instructions to:
pre-process the first input data to at least one of: remove empty user reviews or modify a formatting of a user review of the user reviews.

6. The system of claim 1, wherein the one or more processors are further configured to execute the computer-executable instructions to:
receive, at a second time, second input data from the one or more data sources, the second input data including second user reviews of one or more electric vehicle (EV) charging stations;
determine that the second input data includes a threshold number of user reviews; and
cause, based on determining that the second input data includes a threshold number of user reviews, the second model to update the one or more second summaries based on the first input data and the first output data.

7. The system of claim 1, wherein the first category includes at least one of: functionality and reliability, accessibility and availability, location, price, amenities, user tips, charging speed and efficiency, customer service, or charging station safety, wherein the first output data further includes a sentiment of a user review of the first user reviews, the sentiment including at least one of: positive, negative, or neutral.

8. A method comprising:
receiving, at a first time, first input data from one or more data sources, the first input data including first user reviews of one or more electric vehicle (EV) charging stations;
causing a first model to predict first output data, the first output data including a first category associated with the first input data;
causing a second model to generate one or more first summaries based on the first input data and the first output data;
causing a third model to determine that the one or more first summaries include a hallucination produced by the second model by:
causing the third model to generate one or more first questions using the first input data and the one or more first summaries;
causing the third model to generate one or more first answers to the one or more first questions based on the first input data and one or more second answers to the one or more first questions based on the one or more first summaries; and
determining a difference between the one or more first answers and the one or more second answers;
causing, based on the determination that the one or more first summaries include a hallucination produced by the second model, the second model to generate one or more second summaries; and
causing to present the one or more second summaries via a user interface of a device.

9. The method of claim 8, wherein the first model is an aspect based sentiment analysis (ABSA) model and the second model is a summarization model.

10. The method of claim 8, wherein:
the first user reviews include one or more problems associated with the one or more EV charging stations and one or more solutions to the one or more problems; and
the one or more first summaries include the one or more problems and the one or more solutions.

11. The method of claim 8, wherein determining that the one or more first summaries include a hallucination further comprises:
causing the third model to refine the one or more first questions to produce one or more second questions;
causing the third model to generate one or more third answers to the one or more second questions based on the first input data and one or more second answers to the one or more second questions based on the one or more first summaries; and
determining a second difference between the one or more first answers and the one or more second answers, wherein causing the second model to generate the one or more second summaries is based on the second difference.

12. The method of claim 8, further comprising:
pre-processing the first input data to at least one of: remove empty user reviews or modify a formatting of a user review of the user reviews.

13. The method of claim 8, further comprising:
receiving, at a second time, second input data from the one or more data sources, the second input data including second user reviews of one or more electric vehicle (EV) charging stations;
determining that the second input data includes a threshold number of user reviews; and
causing, based on determining that the second input data includes a threshold number of user reviews, the second model to update the one or more second summaries based on the first input data and the first output data.

14. The method of claim 8, wherein the first category includes at least one of: functionality and reliability, accessibility and availability, location, price, amenities, user tips, charging speed and efficiency, customer service, or charging station safety, wherein the first output data further includes a sentiment of a user review of the first user reviews, the sentiment including at least one of: positive, negative, or neutral.

15. A non-transitory computer-readable medium storing computer-executable instructions, that when executed by one or more processors, cause the one or more processors to perform operations of:
receiving, at a first time, first input data from one or more data sources, the first input data including first user reviews of one or more electric vehicle (EV) charging stations;
causing a first model to predict first output data, the first output data including a first category associated with the first input data;
causing a second model to generate one or more first summaries based on the first input data and the first output data;
causing a third model to determine that the one or more first summaries include a hallucination produced by the second model by:
causing the third model to generate one or more first questions using the first input data and the one or more first summaries;
causing the third model to generate one or more first answers to the one or more first questions based on the first input data and one or more second answers to the one or more first questions based on the one or more first summaries; and
determining a difference between the one or more first answers and the one or more second answers;
causing, based on the determination that the one or more first summaries include a hallucination produced by the second model, the second model to generate one or more second summaries; and
causing to present the one or more second summaries via a user interface of a device.

16. The non-transitory computer-readable medium of claim 15, wherein the first model is an aspect based sentiment analysis (ABSA) model and the second model is a summarization model.

17. The non-transitory computer-readable medium of claim 15, wherein
the first user reviews include one or more problems associated with the one or more EV charging stations and one or more solutions to the one or more problems; and
the one or more first summaries include the one or more problems and the one or more solutions.

18. The non-transitory computer-readable medium of claim 15, wherein determining that the one or more first summaries include a hallucination further comprises:
causing the third model to refine the one or more first questions to produce one or more second questions;
causing the third model to generate one or more third answers to the one or more second questions based on the first input data and one or more second answers to the one or more second questions based on the one or more first summaries; and
determining a second difference between the one or more first answers and the one or more second answers, wherein causing the second model to generate the one or more second summaries is based on the second difference.

19. The non-transitory computer-readable medium of claim 15, wherein the computer-executable instructions further cause the one or more processors to perform operations of:
pre-processing the first input data to at least one of: remove empty user reviews or modify a formatting of a user review of the user reviews.

20. The non-transitory computer-readable medium of claim 15, wherein the computer-executable instructions further cause the one or more processors to perform operations of:
receiving, at a second time, second input data from the one or more data sources, the second input data including second user reviews of one or more electric vehicle (EV) charging stations;
determining that the second input data includes a threshold number of user reviews; and
causing, based on determining that the second input data includes a threshold number of user reviews, the second model to update the one or more second summaries based on the first input data and the first output data.
